(19) United States
(12) Patent Application Publication
(10) Pub. No.: US 2004/0035408 A1
(43) Pub. Date: Feb. 26, 2004

(54) Barbecue grill stand with moveable gas tank storage

(76) Inventor: Charles Szentkuti, Marco Island, FL (US)

Correspondence Address: Edward M. Livingston, Esq., 963 Trail Terrace Drive, Naples, FL, 34103, US

(21) Appl. No.: 10/223,197

(22) Filed: Aug. 20, 2002

(51) Int. Cl. A47J 37/00; F24C 3/00

(52) U.S. Cl. 126/41 R; 126/276

(57) ABSTRACT

A barbecue grill stand (1) having a slidably-mounted carriage assembly (3) for holding an LP fuel tank (6). The carriage assembly (3) is mounted on the two lower parallel struts (2) of a grill stand on a sliding mechanism (12) so that it slides from the side or front of the grill stand for easier, faster and safer installation and removal of LP fuel tanks.

### BACKGROUND OF THE INVENTION

This invention relates to barbecue gas grills and more particularly a barbecue grill stand with a sliding carriage assembly for installing and removing propane gas tanks.

Conventional barbecue grills using propane gas as fuel have a fixed position gas tank storage that requires a person to bend over or kneel when removing and installing propane gas tanks under a grill. In doing so, the gas tank normally has to be balanced on a thin metal bar, a holding wire attached to the top of it and then the grill gas line must be connected to the tank. As the gas tank is relatively heavy, it is a hardship and a cumbersome process to change a gas tank, particularly for elderly people or those with infirmities. In addition to the latter problems, it unsafe to change gas tanks on conventional grills, as it places a person nearer the barbecue grill which may be hot due to use or which may have a gas leak, thereby subjecting a person to a risk of severe burns.

Accordingly, there exists a need for a barbecue grill stand with an easy and safe means of changing the propane gas tank.

The prior patented art includes some patents which disclose devices which have attempted to overcome the above problem but none like the present invention. For instance, U.S. Pat. No. 6,135,104 issued to Lewis, et al. on Oct. 24, 2000 discloses a tilting tank strut to hold a propane gas tank but otherwise still uses a conventional tank attachment system. U.S. Pat. No. 5,960,782 issued to Clements et al. on Oct. 5, 1999 discloses an outdoor grill which has gas tanks attached to a side door which can be opened from the top in order to change tanks. U.S. Pat. No. 4,899,725 issued to Barron, Jr. on Feb. 13, 1990 discloses a grill with an extended bottom platform for supporting a gas tank. U.S. Pat. No. 6,253,760 issued to Mashburn, et al. on Jul. 3, 2001 discloses a grill having a gas canister attached to a swing-out door in a cylinder mount. U.S. Pat. No. 6,293,272 issued to Harneit on Sep. 25, 2001 discloses a mount to a gas grill with a swing-out auxiliary cook burner that is stored within the cabinet when not in use. U.S. Pat. No. 5,931,149 issued to Lewis on Aug., 3, 1999 discloses a similar device as in the Lewis, et a '104 patent discussed above. U.S. Pat. No. 5,458,309 issued to Craven, Jr. et al. on Oct. 17, 1995 discloses a gas grill with a recess in the bottom platform to hold the gas tank in a safer position farther away from the fire. U.S. Pat. No. 6,308,616 issued to Johnson on Oct. 30, 2001 discloses a grill with a sliding cover for auxiliary burners so the burner top can be used as a shelf when the burner is not needed. Finally, U.S. Pat. No. 5,458,309 issued to Craven, Jr. et al. on Oct. 17, 1995 discloses a top wire tank support having a middle spring section and pivotable end so a tank can be removed more easily.

Although there are many gas tank holding systems disclosed in the prior art, none features a sliding carriage assembly for placing the gas tank in a position away from the bottom grill housing, so the gas line connection from the grill or tank can be done in an easy and safe manner and then returned under the grill housing.

### SUMMARY OF THE INVENTION

The primary object of the present invention is to provide a barbecue grill stand support structure which makes it easier to install and remove propane gas tanks.

Another object of the present invention is to provide a safer means for installing and removing gas tanks on barbecue grills.

An even further object of the present invention is to provide a faster way of changing gas tanks on barbecue grills.

The present invention fulfills the above and other objects by providing a barbecue grill stand for use with a grill that uses LP fuel having a support structure for the grill that has at least two lower parallel struts onto which the carriage assembly of the present invention is supported. The carriage assembly has an LP tank support housing with a top platform for holding the LP tank and two sides as slidably-mounted on the sliding mechanism. The sliding mechanism may consist of a plurality of rollers which attach to the top and bottom of each side of the carriage assembly. The rollers are slidably supported within a channel mounted on the struts of the grill support structure. The carriage assembly may have a rolling support caster on its uppermost or distal end to help support the weight of the LP tank on the carriage assembly particularly when the carriage assembly is slid out from under the grill support structure for installing or removing the LP tank. The distal end of the carriage assembly may have a handle to assist in pulling it out from under the grill. The tank support housing may have a circular recess into which the LP tank rests to further support it on the assembly. The carriage assembly may be mounted on the parallel struts and either slides out the side of the grill stand or the front of the grill stand.

### BRIEF DESCRIPTION OF THE DRAWINGS

In the following detailed description, reference will be made to the attached drawings in which:

FIG. 1 is a prospective view of the barbecue grill stand of the present invention showing the carriage assembly below the grill housing with a side slide-out embodiment;

FIG. 2 is a perspective view of the barbecue grill stand of the present invention with the carriage assembly in a side slide-out position;

FIG. 3 is a partial cross-section view along lines 3-3 on FIG. 1 showing one embodiment of the sliding mechanism of the barbecue grill stand of the present invention;

FIG. 4 is a top view of the gas tank carriage mount by itself;

FIG. 5 is a side end view of the carriage assembly of the barbecue grill stand of the present invention;

FIG. 6 is a perspective view of the barbecue grill carriage assembly of the present invention with a front slide-out;

FIG. 7 is a perspective view of the barbecue grill carriage assembly of the present invention having a front slide-out in a slide-out tank-changing position;

FIG. 8 is a partial cross-section view along lines 8-8 of FIG. 6 of the barbecue grill stand with the carriage assembly and tank of the present invention;

FIG. 9 is a top view of the grill stand carriage assembly of the front slide-out embodiment; and

FIG. 10 is a front view of the grill stand carriage assembly with the front slide-out embodiment.

### DESCRIPTION OF THE PREFERRED EMBODIMENTS

For purposes of describing the preferred embodiment, the terminology used in reference to the numbered components in the drawings is as follows:

```
  1. Grill stand, generally
  2. Lower support struts
  3. Sliding carriage assembly
  4. Casters
  5. Casters
  6. Tank
  7. Carriage support caster
  8. Tank support housing
  9. Sliding channel
10. Slide support of carriage assembly
11. Carriage assembly rollers
12. Sliding support bars
13. Gas tank recess
14. Carriage handle
15. Carriage support bracket
16. Mounting holes
17. Vertical support bars of grill
18. Top cross support struts
```

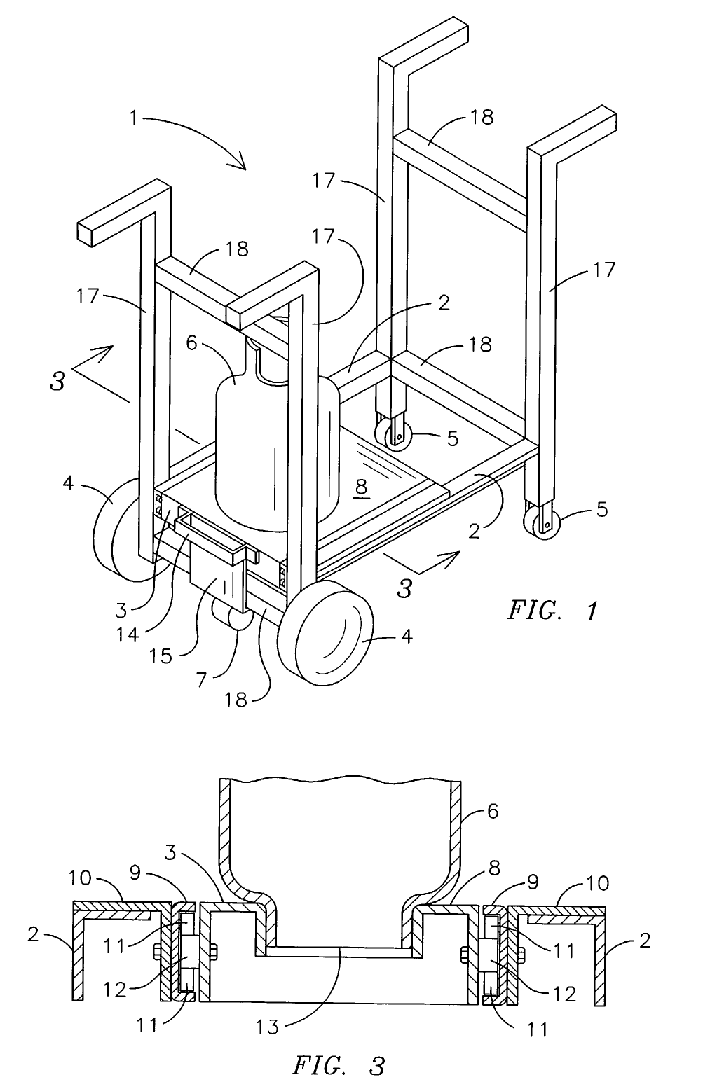

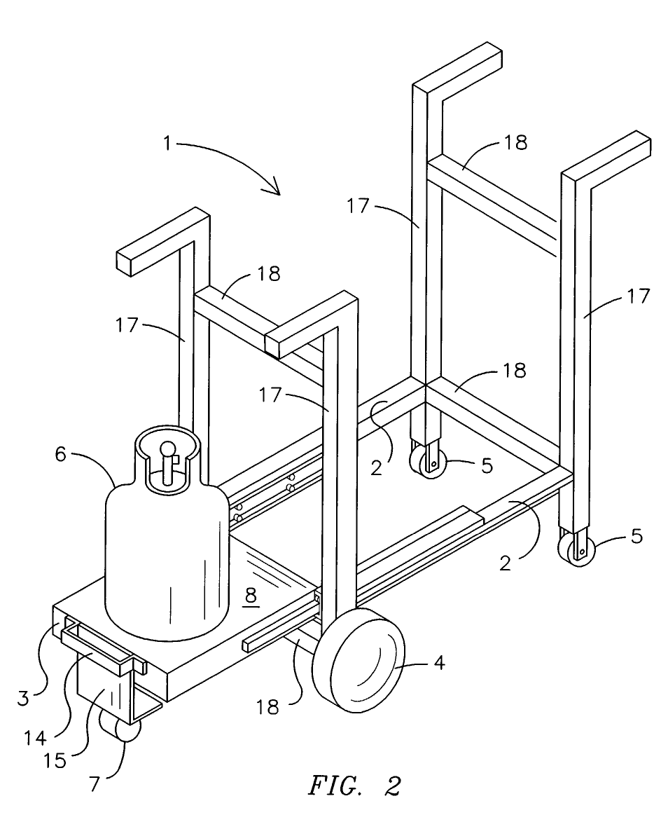

Referring to the FIGS. 1 and 2, a grill stand 1 is shown having vertical support bar 17 connected at the top and bottom by cross-support struts 18 and 2 respectively. The grill support stand may be mounted on rolling casters 4 and 5, which are preferably locking, mounted at the bottom of each vertical support bar 17. Although the latter structure is typical of a conventional gas barbecue grill stand, the grill stand of the present invention further has a tank support carriage assembly 3 slidably-mounted on the two lower parallel support struts 2. As shown in FIG. 1, the tank support carriage housing 3 may have a rolling support caster 7 mounted under a support bracket 15 on a distal end of the housing. The support housing 3 may also have a handle 14 on the distal end to assist in pulling and sliding the carriage assembly out from under and away from the grill stand 1 as is illustrated in FIG. 2.

FIG. 3 shows further details of the carriage assembly 3 and more particularly the sliding mechanism used to pull out the assembly 3 away from the grill stand 1. The sliding mechanism preferably comprises a plurality of rollers 11 mounted on a top and bottom of each side of the carriage assembly 3. Two support bars 12, one on each side of the carriage assembly 3, are slidably-mounted with roller carriage 11 between two U-shaped sliding channels 9 mounted on the slide support 10 mounted on one lower support strut 2 of the grill stand 1. A circular recess or opening 13 in the tank support housing 8 can be provided to more securely hold an LP tank 6 on the carriage assembly 3.

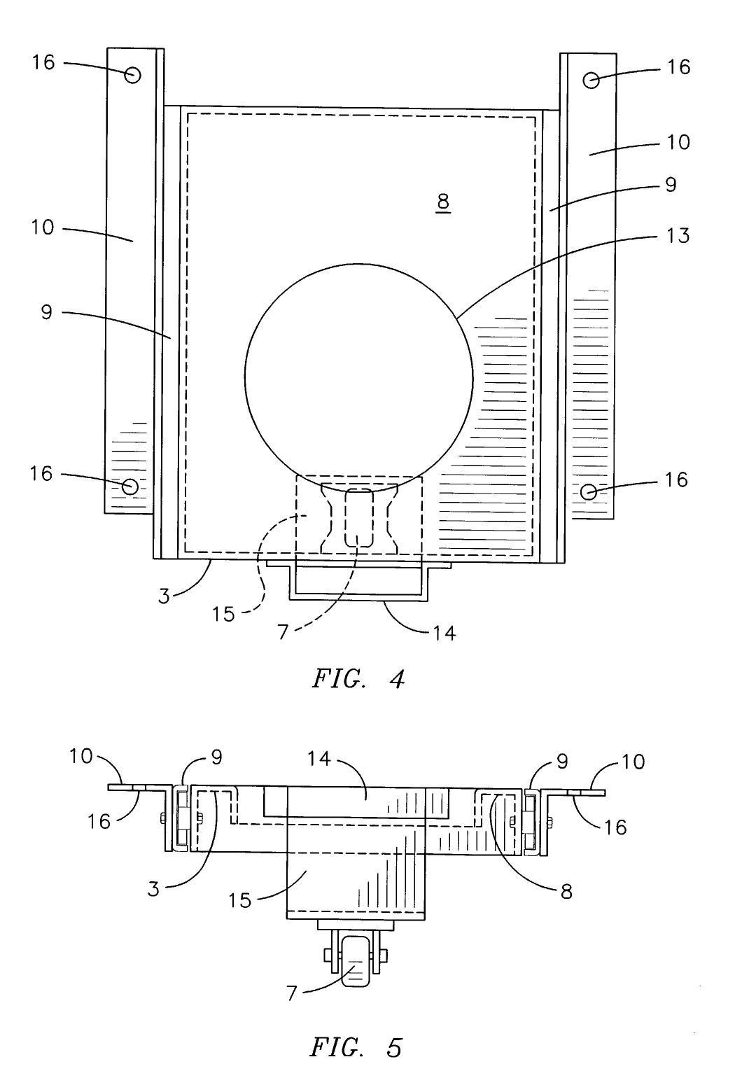

FIG. 4 shows a top view of the carriage support assembly 3 without an LP tank. Mounting holes 16 on each of the support struts 10 into which screws, nuts and bolts or similar fastening means may be utilized to secure the carriage assembly 3 to the lower support struts 2 on the grill support stand 1.

FIG. 5 shows the carriage assembly 3 having a rolling caster 7 mounted under a support bracket 15 on a distal end to provide further support for the carriage assembly 3 when it is rolled out and away from the grill stand 1 while installing a heavy LP tank. A handle 14 is provided to assist pulling the carriage assembly 3 from the grill stand 1.

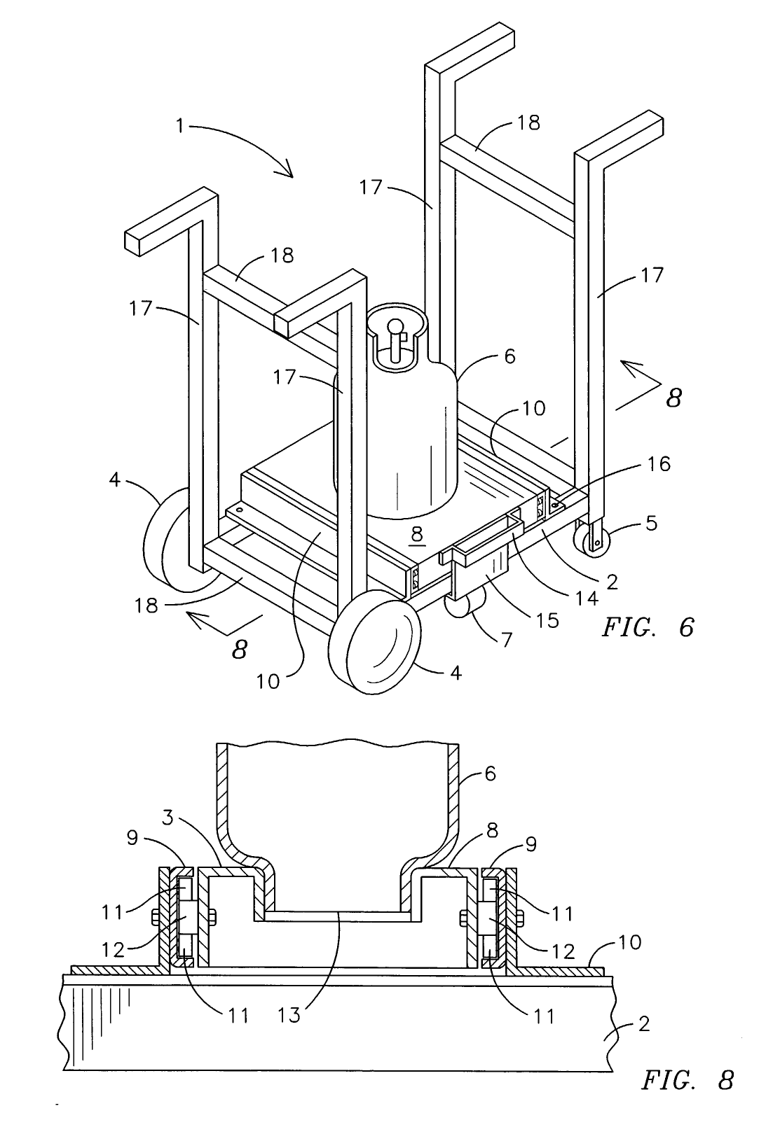

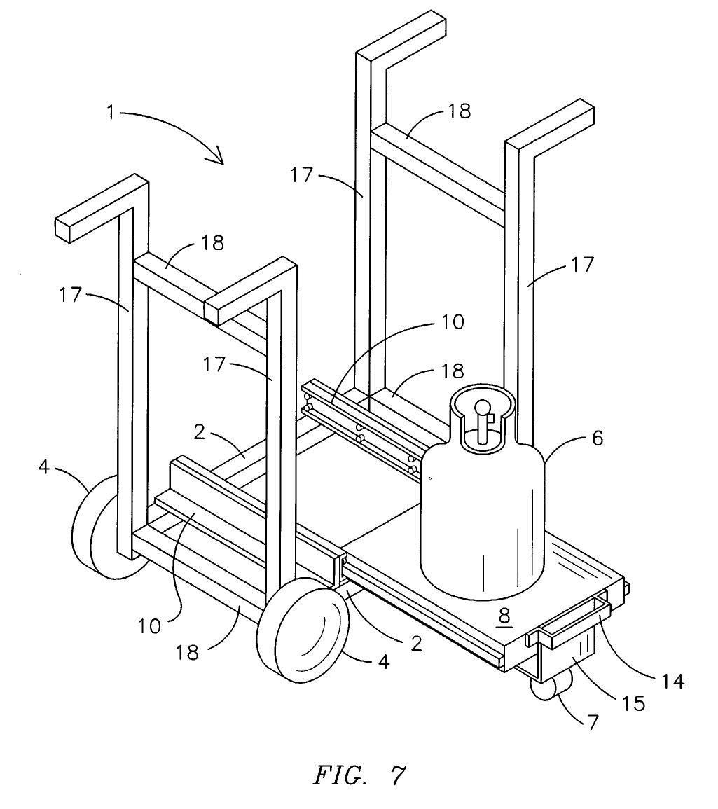

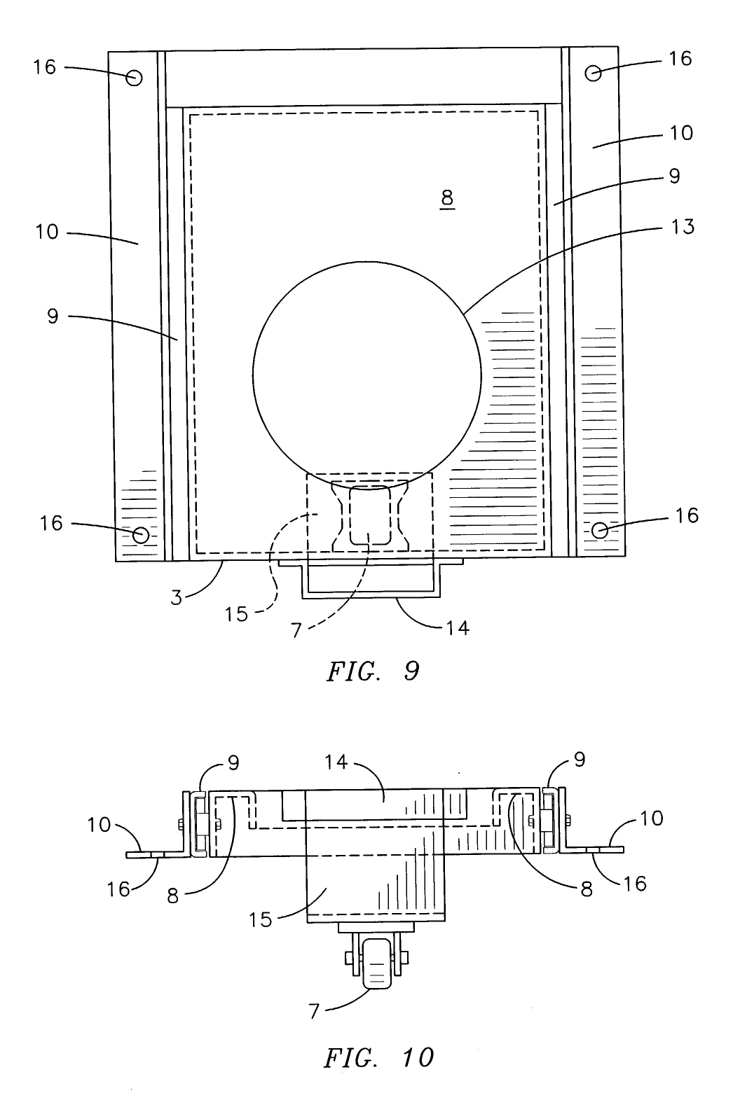

FIG. 6 illustrates the carriage support assembly 3 when it is mounted on the support struts 2 so that it slides out from the front of the grill stand 1, as opposed to a side of the grill stand 1 as illustrated in previous drawings. In this front slide-out embodiment the carriage support assembly 3 is mounted on and particularly to the lower support strut 2 rather than between struts 2 as in the side slide-out embodiment. Other than the latter difference, the components of the grill support assembly in a front slide-out embodiment as illustrated in FIGS. 6-10 have the same structure and operation.

Although only a few embodiments of the present invention have been described in detail hereinabove, all improvements and modifications to this invention within the scope or equivalents of the claims are included as part of this invention.

Having thus described my invention, I claim:

1. A barbecue grill stand for use with a grill that uses LP fuel, said stand comprising;
a support structure for a grill having at least two lower parallel struts;
a carriage assembly supported by and slightly mounted between said at least two struts, said assembly having an LP tank support housing with a top platform for holding the LP tank on two sides for support in the carriage assembly in a sliding mechanism so the carriage assembly can be slid outward from under the grill as necessary to install and remove the LP tank.

2. The barbecue grill stand of claim 1 wherein the slide-out mechanism comprises a plurality of rollers attached to a top and bottom of each side of the carriage assembly, said rollers being supported within a channel mounted on the at least two struts of the grill support structure.

3. The barbecue grill stand of claim 1 wherein the carriage assembly comprises a rolling support caster mounted under a distal end of the carriage assembly to provide support for the weight of the LP tank.

4. The barbecue grill stand of claim 2 wherein the carriage assembly comprises a rolling support caster mounted under a distal end of the carriage assembly to provide support for the weight of the LP tank.

5. The barbecue grill stand of claim 1 wherein the carriage assembly further comprises a handle on a distal end to assist in pulling the carriage assembly from under the grill support structure.

6. The barbecue grill stand of claim 2 wherein the carriage further comprises a handle on a distal end to assist in pulling the carriage assembly from under the grill support structure.

7. The barbecue grill stand of claim 3 wherein the carriage assembly comprises a rolling support caster mounted under a distal end of the carriage assembly to provide support for the weight of the LP tank.

8. The barbecue grill stand of claim 4 wherein the carriage assembly comprises a rolling support caster mounted under a distal end of the carriage assembly to provide support for the weight of the LP tank.

9. The barbecue grill stand of claim 1 wherein the carriage assembly further comprises a circular recess in the tank support housing to further secure the LP tank in the carriage assembly.

10. The barbecue grill stand of claim 2 wherein the carriage assembly further comprises a circular recess in the tank support housing to further secure the LP tank in the carriage assembly.

11. The barbecue grill stand of claim 3 wherein the carriage assembly further comprises a circular recess in the tank support housing to further secure the LP tank in the carriage assembly.

12. The barbecue grill stand of claim 4 wherein the carriage assembly further comprises a circular recess in the tank support housing to further secure the LP tank in the carriage assembly.

13. The barbecue grill stand wherein the carriage assembly further comprises a circular recess in the tank support housing to further secure the LP tank in the carriage assembly.

14. The barbecue grill stand wherein the carriage assembly further comprises a circular recess in the tank support housing to further secure the LP tank in the carriage assembly.

15. The barbecue grill stand of claim 7 wherein the carriage assembly further comprises a circular recess in the tank support housing to further secure the LP tank in the carriage assembly.

16. The barbecue grill stand of claim 8 wherein the carriage assembly further comprises a circular recess in the tank support housing to further secure the LP tank in the carriage assembly.

17. The barbecue grill stand of claim 1 wherein the carriage assembly is mounted between the at least two parallel struts that it slides out a side of the grill stand.

18. The barbecue grill stand of claim 2 wherein the carriage assembly is mounted between the at least two parallel struts that it slides out a side of the grill stand.

19. The barbecue grill stand of claim 1 wherein the carriage assembly is mounted between the at least two parallel struts that it slides out the front of the grill stand.

20. The barbecue grill stand of claim 2 wherein the carriage assembly is mounted between the at least two parallel struts that it slides out the front of the grill stand.
